(19) United States
(12) Patent Application Publication
(10) Pub. No.: US 2006/0097495 A1
(43) Pub. Date: May 11, 2006

(54) Retaining system

(76) Inventor: Frank-Juergen Stuetzler, South Lyon, MI (US)

Correspondence Address: KENYON & KENYON LLP, ONE BROADWAY, NEW YORK, NY, 10004, US

(21) Appl. No.: 10/519,268

(22) PCT Filed: Feb. 14, 2003
(86) PCT No.: PCT/DE03/00449

§ 371 Date: Sep. 27, 2005

(30) Foreign Application Priority Data
Jun. 18, 2002 (DE) 102 27 061.9

(51) Int. Cl. B60R 21/16

(52) U.S. Cl. 280/735

(57) ABSTRACT

A restraint system which, in addition to at least one acceleration-sensitive sensor, includes at least one ultrasonic sensor which analyzes ultrasonic signals which occur in the event of an accident.

### FIELD OF THE INVENTION

The present invention relates to a restraint system.

### BACKGROUND INFORMATION

Conventional restraint systems determine the deployment of restraining means via the acceleration which is measured on the transmission tunnel in the passenger compartment or in the exterior area of the vehicle, in the B-pillars for example, using peripheral sensors. Two acceleration sensors for each sensing direction are typically used to avoid erroneous deployment. The signals of both sensors are compared with one another and the deployment of restraining means, such as airbags for example, is permitted only when both sensors measure a significant acceleration signal. Such a restraint system is described in German Patent Application No. DE 197 39 655. A first acceleration-sensitive sensor is provided in this conventional restraint system, a first deployment criterion being derived from its output signal. A second deployment criterion is derived from the output signal of at least one additional sensor. At least two complex sensor systems are thus required to achieve a highly reliable performance of the restraint system and to prevent erroneous deployments in particular.

An accident sensor for triggering a motor vehicle safety system is described in German Patent Application No. DE 197 45 309. This sensor includes deformable plastic parts which are mounted on the vehicle, as well as a microphone, in particular a structure-borne sound sensor. The deformation of the plastic parts generates a structure-borne sound that is measured in the frequency range of 60 Hz to 100 Hz.

### SUMMARY

In accordance with an example embodiment of the present invention, a substantially simpler and yet reliable restraint system is provided. In the event of an accident, high-frequency acoustic signals are generated which may be converted into corresponding electrical signals using an electroacoustic transducer and may be analyzed as to whether an accident event is occurring. Particularly advantageous is the use of an ultrasonic sensor as the electroacoustic transducer, since acoustic signals of high amplitude in the ultrasound range are generated during accident events. An additional deployment criterion for the deployment of restraining means may be derived from these easily analyzable signals in a relatively simple manner.

### BRIEF DESCRIPTION OF THE DRAWINGS

The present invention is explained in greater detail below with reference to the exemplary embodiments illustrated in the figures.

FIG. 1 shows in a diagram the output signal of an ultrasonic sensor as a function of time in an accident experiment.

FIG. 2 shows a first exemplary embodiment of the present invention in which an ultrasonic sensor is situated in the control unit for sensing the passenger compartment.

FIG. 3 shows a second exemplary embodiment in which an ultrasonic sensor is situated in the airbag control unit.

FIG. 4 shows a third exemplary embodiment in which an ultrasonic sensor is also situated in the passenger compartment of the vehicle but outside of the airbag control unit.

### DETAILED DESCRIPTION OF EXAMPLE EMBODIMENTS

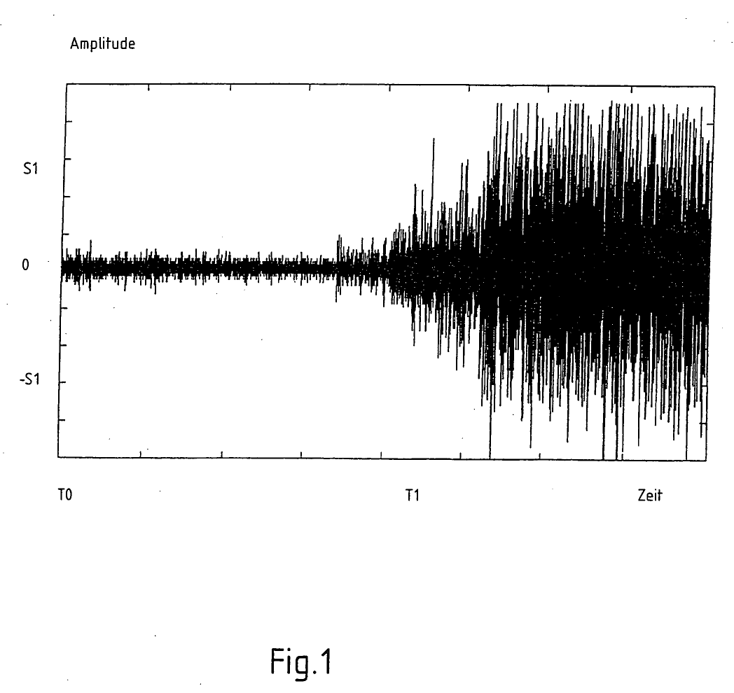

FIG. 1 shows in a diagram the output signal of an electroacoustic transducer, in particular an ultrasonic sensor, as a function of time in an accident experiment. During the simulation of a very wide variety of vehicle accidents, the output signal of such an ultrasonic sensor US shows high amplitude values in a high frequency range of beyond approximately 50 kHz. In the diagram illustrated in FIG. 1, the output signal of ultrasonic sensor US is detected starting at point in time T=T0 as part of a crash experiment. The vehicle collides with a rigid barrier at a velocity of approximately 50 km/h at point in time T=T1. As the diagram shows, the amplitude of the output signal of ultrasonic sensor US surges within a very short period of time, thereby representing a signal that may be analyzed comparatively simply. The generation of such ultrasonic signals is attributed to the deformation and breaking of vehicle parts during an accident.

An ultrasonic sensor US, situated in the passenger compartment of a vehicle, detects the ultrasonic signals in the vehicle in the event of an accident. In this instance, the ultrasonic sensor may be situated in the airbag control unit itself, or in another control unit, e.g., the control unit provided for sensing the passengers. As an external sensor, the ultrasonic sensor may alternatively be situated at almost any location within the passenger compartment of the vehicle. In the event that the ultrasonic sensor is installed in the airbag control unit itself, the measured signal is analyzed together with the signals of acceleration sensors which are also present there. In the event that the ultrasonic sensor is situated in a different control unit, its output signal is transmitted to the airbag control unit and analyzed there. A particularly advantageous analysis of the output signal of the ultrasonic sensor may take place in such a way that the output signal is initially filtered in a low-pass filter and subsequently compared with a predefinable threshold value. If the threshold value is exceeded, this qualifies as a plausibility decision for the fact that an accident event is occurring. This plausibility decision is gated with the output signals of additional sensors of the restraint system. If the output signal of the ultrasonic sensor, as well as the output signals of the additional sensors of the restraint system conclude that an accident event is occurring, the deployment of restraining means such as airbags and seat-belt tensioners is enabled.

In further advantageous embodiments of the present invention, the output signal of the ultrasonic sensor may also be analyzed by using integration, window integration, bandpass filtering, or a combination of these measures.

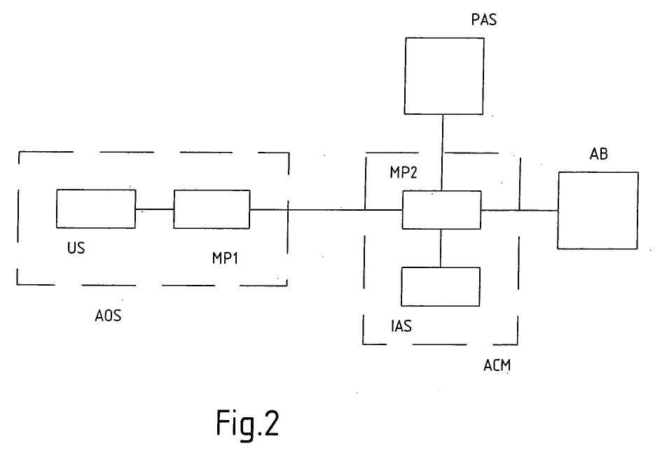

A first exemplary embodiment of the present invention is explained with reference to FIG. 2, in which ultrasonic sensor US is situated in control unit AOS for sensing the passenger compartment. Ultrasonic sensor US is connected to a first microprocessor MP1 which is situated in control unit AOS. Control unit AOS for sensing the passenger compartment is connected to airbag control unit ACM. A second microprocessor MP2 and a first acceleration-sensitive sensor IAS of the restraint system are situated in airbag control unit ACM. A second acceleration-sensitive sensor PAS of the restraint system is connected to airbag control unit ACM. First sensor IAS is a sensor situated inside the vehicle, while second sensor PAS is situated externally. The output of control unit ACM is connected to a restraining means AB, such as an airbag in particular.

The first exemplary embodiment of the present invention operates as follows. In the event of an accident, acceleration-sensitive sensors IAS and PAS respond and each output a corresponding output signal. In addition, ultrasonic sensor US, which is situated in control unit AOS for sensing the passengers, detects the high-frequency acoustic oscillations caused by the deformation or breaking of vehicle parts and converts these into a corresponding electrical output signal (FIG. 1). High-frequency oscillations starting at approximately 50 kHz are preferably analyzed, since they are particularly characteristic of accident events. The output signal of ultrasonic sensor US is supplied to a low-pass filter (not shown in FIG. 2) and analyzed there. The output signal, filtered in this way, is finally supplied to a threshold circuit and compared there with a predefinable threshold value S1. If the filtered output signal exceeds predefinable threshold value S1, it is assessed as a critical signal indicating an accident. If all three sensors, IAS, PAS, and US, deliver critical signals, i.e., signals which indicate an accident, everything suggests that an accident must plausibly be assumed and thus restraining means AB, such as, for example, airbags and/or seat-belt tensioners, must be deployed. This first exemplary embodiment according to FIG. 2 is characterized in particular in that it has a very compact and space-saving design, since ultrasonic sensor US is situated in control unit AOS for sensing the passengers. This space-saving configuration makes particularly short electrical connections between ultrasonic sensor US and first microprocessor MP1 possible.

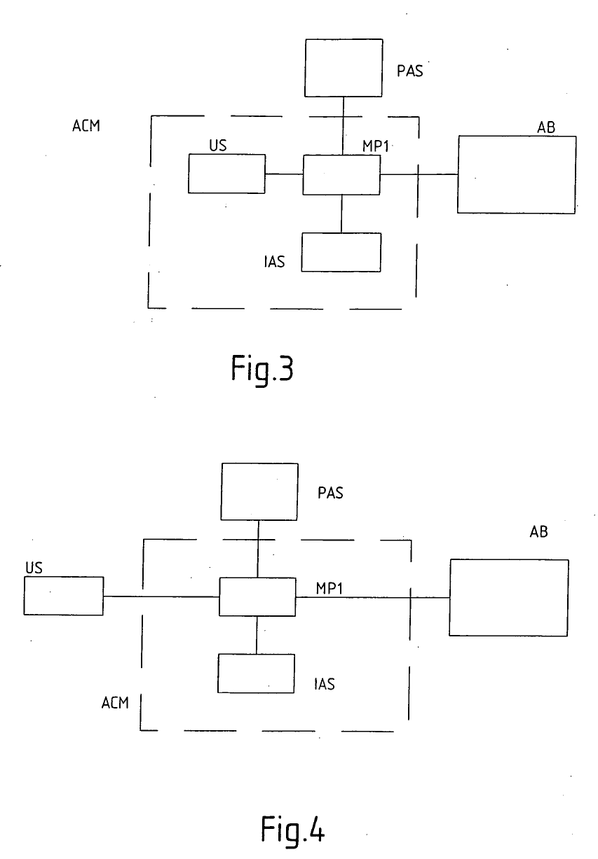

A second exemplary embodiment of the present invention is described in connection with FIG. 3. An airbag control unit ACM is illustrated there in the form of a block diagram. This airbag control unit ACM includes a first, internally situated acceleration sensor IAS and a microprocessor MP1. In addition, an external, acceleration-sensitive sensor PAS is connected to control unit ACM. An ultrasonic sensor US is situated directly in control unit ACM. In comparison with the first exemplary embodiment according to FIG. 2, this results in an even more compact configuration having particularly short power connections between sensors IAS, US and microprocessor MP1 which is responsible for the analysis of the output signals of these sensors.

A third exemplary embodiment of the present invention is explained with reference to FIG. 4. An airbag control unit ACM is again illustrated, which includes an acceleration-sensitive sensor IAS and a microprocessor MP1. An externally situated acceleration sensor PAS is connected to control unit ACM. In addition, an ultrasonic sensor US is provided which is, however, situated outside control unit ACM and connected to it via a line. This exemplary embodiment of the present invention mentioned last is not as compact as the exemplary embodiments of the present invention explained above with reference to FIGS. 2 and 3. However, a great advantage lies in the fact that in this exemplary embodiment, from the configurational point of view, the ultrasonic sensor may be mounted in an optimal location, independently of control units ACM or AOS. This exemplary embodiment is thus particularly flexible.

It is generally known that an impact on the vehicle body, falling rocks for example, or driving over a pothole, generates acoustic oscillations. However, such oscillations subside again relatively quickly. In order to reliably prevent an erroneous deployment of restraining means in the presence of such innocuous acoustic oscillations, a time threshold is additionally provided in an advantageous further embodiment of the present invention. This means that threshold value S1 must be exceeded at least during a time interval ΔT before the ultrasonic signal is considered to be critical.

1-8. (canceled)

9. A restraint system, comprising:
a restraining device which includes at least one acceleration-sensitive sensor, and at least one additional sensor, the at least one additional sensor including an electroacoustic transducer which is sensitive to ultrasonic waves, which are generated in the event of an accident, the electroacoustic transducer configured to generate an output signal from which a deployment criterion for the restraining device is derivable.

10. The restraint system as recited in claim 9, wherein the electroacoustic transducer is an ultrasonic sensor.

11. The restraint system as recited in claim 10, wherein a threshold value is predefinable for the output signal of the ultrasonic sensor, and wherein the output signal exceeding the threshold value is assessed as a deployment criterion for the restraining device.

12. The restraint system as recited in claim 10, further comprising:
an arrangement configured for generating a deployment criterion for the restraining device, the arrangement configured to subject the output signal of the ultrasonic signal to at least one of an integration, a window integration and bandpass filtering.

13. The restraint system as recited in claim 10, wherein the ultrasonic sensor is situated in a first airbag control unit.

14. The restraint system as recited in claim 10, wherein the ultrasonic sensor is situated in an airbag control unit which is responsible for sensing passengers.

15. The restraint system as recited in claim 10, wherein the ultrasonic sensor is situated in the vehicle, spatially separated from a first airbag control unit and a second airbag control unit.

16. The restraint system as recited in claim 10, wherein a time interval is provided for the output signal of the ultrasonic sensor in such a way that the deployment criterion for the restraining device is present only when a threshold value is exceeded at least during the time int
